(19) United States
(12) Patent Application Publication
(10) Pub. No.: US 2026/0043699 A1
(43) Pub. Date: Feb. 12, 2026

(54) TESTING AND CONSTITUTIVE MODELING OF CREEP FOR WIRELINE CABLES

(71) Applicant: Schlumberger Technology Corporation, Sugar Land, TX (US)

(72) Inventors: Haitao Zhang, Sugar Land, TX (US); Muhannad Abdelaziz Abuhaikal, Cambridge, MA (US); Sheng Chang, Sugar Land, TX (US); Viraj Singh, Sugar Land, TX (US); Shiqiang Wen, Houston, TX (US)

(21) Appl. No.: 19/208,642

(22) Filed: May 15, 2025

Related U.S. Application Data
(60) Provisional application No. 63/648,938, filed on May 17, 2024.

(51) Int. Cl. G01L 5/04; G06F 30/20; G06F 113/16

(52) U.S. Cl. CPC G01L 5/04; G06F 30/20; G06F 2113/16

(57) ABSTRACT

A method and system for monitoring cable creep may include using a constitutive model. A method and system for characterizing creep of wireline cables, the method comprising the steps of providing a wireline cable with a gauge section, fixing a first end of the wireline cable, connecting a second end of the wireline cable to a load cell, wherein the load cell applies and controls tension on the wireline cable, attaching an extensometer to the first end and the second end of the wireline cable, wherein the extensometer is used to measure the length change of the gauge section, and recording one or more data of the wireline cables to characterize the creep of the wireline cables.

### BACKGROUND

Wireline cables are used as a conveyance for the acquisition of subsurface geophysical and petrophysical data and delivery of various well construction services such as pipe recovery, perforating, plug setting, well cleaning, and fishing. For wireline jobs, position of the downhole tools is usually critical for quality of service. Obtaining correct prediction and control of the depth of downhole tools is important for the success of a wireline job.

Various ways for depth estimation and control are currently used. The traditional way for estimation of wireline depth is through measurement by a depth wheel or a depth encoder on the surface to estimate the length of the cable and by considering tension stretch and thermal expansion of the cable. This method becomes inaccurate for complex job conditions where the wireline is subjected to extended depth, variation of tool configurations (weight), and long time at elevated temperature where creep of the cable becomes significant to length change of the cable. Other methods include direct downhole measurement of tool movement, using standard depth referencing points or stretch correction marks. These methods are often time consuming, depending on prerequisites and availability of other tools and measurements, and unsuitable for real-time operations. Note that other than change of cable length, continuous movement of downhole equipment can cause inaccurate estimation of wireline tools. This is due to toolstring momentum and wave propagation and affected by viscosity of wellbore fluid, friction, and wellbore profile. This type of “creep” is a short-time event compared to the mechanical creep of cable.

The mechanical response of wireline cables is complexed with their structural configurations and material compositions. The actual complexity depends on type of the cable, which varies with job and operations. Most wireline cables have a multilayer structure, which has electrical conductors to transmit electric power or signals; elastomer or polymer insulation layers and filler material; and mechanical elements, usually the armor wires to carry mechanical loads such as the weight of the downhole tools and torque. The armor wires are wound around the core of conductors, which are bound together with insulation material. The elements contribute to creep behavior in different ways, and their interactions need be considered as well. Elastomers and polymers usually show significant time-dependent viscoelastic and viscoplastic behavior where molecular chains slide past each other under stress. Creep of polymers can happen at low environment temperatures whereas for metals, creep involves the movement of dislocations and can be influenced by the crystal structure, grain boundaries, and phase distribution. Metal creep typically occurs at higher temperatures. Research on creep of wireline cables is rare in literature. However, a wealth of creep studies exists for polymer or steel ropes used as tension members in engineering applications.

Nakai et al., studied creep and relaxation of spiral ropes both experimentally and theoretically. Important findings are that the extent of creep of spiral ropes is proportional to the number of layers the rope has, and the clearance between wire layers has important effect. Creep of spiral ropes is investigated with finite element modeling as described by Ivanco et al., 2016, which provides additional insight of the experimental findings of Nakai et al. Guimaraes & Burgoyne, 1992 meanwhile performed a creep test of a parallel-lay aramid rope and used a logarithmic time law to describe the creep behavior. Zhang et al., 2020 conducted a creep test of small-diameter steel cables and used the linear viscoelastic Kelvin chain model to describe the constitutive behavior. In Zhang's study, both the primary and secondary creep of the steel cables were captured.

Therefore, there is a need for simple models capable of predicting extension of wireline cable efficiently.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a schematic of a wireline cable with traditional hepta-design, according to one or more examples of the disclosure.

FIG. 2 is a schematic showing the cable creep testing setup, according to one or more examples of the disclosure.

FIG. 3a is a graph illustrating test results under cyclic tensile loading and unloading under a 12,000 lb force, according to one or more examples of the disclosure.

FIG. 3b is a graph illustrating test results under cyclic tensile loading and unloading under a 12,000 lb load, according to one or more examples of the disclosure.

FIG. 4a is a graph illustrating creep result showing elongation under different tension load, according to one or more examples of the disclosure.

FIG. 4b is a graph illustrating creep result showing normalized elongation under different tension load, according to one or more examples of the disclosure.

FIG. 5 is a graph depicting a master curve of creep for a wireline cable, according to one or more examples of the disclosure.

FIG. 6 is an illustration of an example method for predicting length changes of a wireline cable in field operations.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

In the present invention, an approach including testing to characterize creep of wireline cables and a one-dimensional constitutive model to predict time-dependent and temperature-dependent elongation of wireline cables under downhole conditions including temperature and tension was developed. Creep of the cable is modeled with linear viscoelasticity using the Voigt-Wiechert model, and the model includes a single linear spring and multiple Kelvin-Voigt elements in series. The constitutive model is represented by a Prony series. A typical wireline cable is selected as an example. Coefficients of the Prony series are calibrated with test data. A test procedure is developed for characterizing creep of wireline cables. The calibrated constitutive model is verified in ABAQUS by comparing the predicted creep behavior of the cable under different temperatures with test measurement data. The developed cable characterization testing procedure can be readily applied to other wireline cables. The developed cable constitutive model can be easily implemented in computer programs and allows for real-time estimation and control of cable depth under complex wireline job conditions.

### Methods

The one-dimensional constitutive model and the testing for modeling and characterizing the creep behavior of wireline cables is further described below.

### Constitutive Model

Both thermal expansion and mechanical loading of tension contribute to elongation of the cable, so the total elongation of the cable can be written as

$$ε ( t ) = {ε}_{θ} + {ε}_{T} ( t ) \qquad ( 1 )$$

The thermal-induced elongation ε_θ can be obtained by

$${ε}_{θ} = α \cdot Δθ \qquad ( 2 )$$

where Δθ=θ−θ_{ref} is the temperature change, θ_{ref} is the reference temperature, and α is the coefficient of thermal expansion (CTE) along the longitudinal direction.

The mechanical-induced elongation can be obtained from linear viscoelasticity:

$${ε}_{T} ( t ) = {T}_{0} J ( {t}^{*} ) + {\int }_{0}^{{t}^{*}} J ( {t}^{*} - {t}^{′} ) \frac{dT}{{dt}^{*}} {dt}^{′} \qquad ( 3 )$$

where J(t) is the creep compliance function which is obtained from the Voigt-Wiechert model and can be written as a Prony series:

$$J ( t ) = {J}_{0} + {\sum }_{i = 1}^{N} {J}_{i} ( 1 - {e}^{- \frac{t}{{τ}_{i}}} ) \qquad ( 4 )$$

$$where {J}_{0} = \frac{1}{{E}_{0}} , {J}_{i} = \frac{1}{{E}_{i}} , {τ}_{i} = \frac{{η}_{i}}{{E}_{i}} ,$$

and t* is the equivalent time after time-temperature correction:

$${t}^{*} = {\int }_{0}^{t} \frac{d ξ}{{a}_{T} ( θ ( ξ ) )} \qquad ( 5 )$$

where a_{T} is the time shift function and depends on temperature.

Investigating equations (1) to (5), the following coefficients of the constitutive model need be determined before use: α, J₀, Jᵢ, (i=1 . . . N), and the time-temperature function a_{T}. The number of coefficients depends on the number of Voigt elements in the model. Note that creep compliance equation (4) is the master curve describing the creep response.

Creep tests that can be used to calibrate these coefficients for wireline cables and determine the creep master curve are further described in the next section.

### Testing

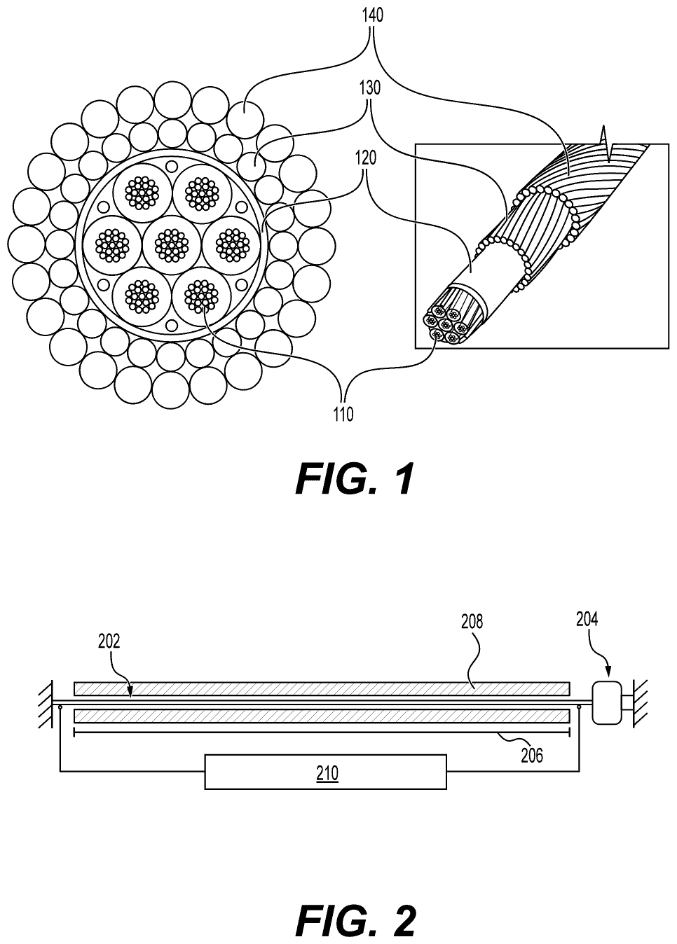

Creep tests were conducted on a typical wireline cable that contains similar structure, as shown in FIG. 1. Conductor wires 110 can comprise one or more electrically conductive elements, such as copper, aluminum, or copper-clad steel, which are capable of transmitting electrical power and/or data signals. These conductors may be solid or stranded to provide a desired balance of flexibility, conductivity, and mechanical robustness.

The conductor wires 110 are enclosed within a jacket 120, which may be formed from an insulating and protective material such as cross-linked polyethylene (XLPE), ethylene propylene rubber (EPR), or polyvinyl chloride (PVC). The jacket 120 serves to electrically insulate the conductors, prevent short circuits, and provide an initial barrier against mechanical damage, moisture ingress, and chemical exposure.

Surrounding the jacket 120 is an inner armor layer 130. The inner armor 130 may be composed of a helically wound strip or wire formed of galvanized steel, stainless steel, or other corrosion-resistant metallic materials. The inner armor provides mechanical protection against tensile, compressive, and torsional stresses that may be encountered during deployment and retrieval operations, particularly in downhole or subsea environments. In some configurations, the inner armor may also contribute to the tensile load-bearing capacity of the cable.

Encasing the inner armor 130 is an outer armor layer 140. The outer armor 140 may be similarly formed of helically wound metal wires or strips, and may be constructed from materials such as high-strength galvanized steel or corrosion-resistant alloys, depending on the environmental conditions and required strength characteristics. The outer armor functions as an additional mechanical protection layer, shielding the inner components from abrasion, impact, and harsh handling conditions. In some designs, the outer armor may be counter-helically wound relative to the inner armor to improve torque balance and cable stability.

The tests were conducted at different temperatures and under different loading levels. FIG. 2 illustrates the test setup. The test was done horizontally. The cable specimen 202 is 20 ft long. One side of the cable specimen 202 is fixed, and the other side is connected to a load cell 204, which applies and controls the tension on the cable specimen 202. The gauge section 206 of the cable is in a temperature chamber 208. An extensometer 210 attached directly to the cable specimen 202 is used to measure the length change of the gauge section 206 of the cable specimen 202 during the test. Tension, elongation of the specimen 202, and temperature are recorded during the test.

For each specimen, three testing phases occurred; seasoning, cyclic and creep.

Seasoning phase: In this phase, the cable specimen is stepwise loaded to different tensions at both room temperature and an elevated temperature of 350° F. The loads are selected at 25%, 50%, 75%, and 100% of a specified peak tension. Both the peak tension and the temperature selections should be based on the cable rating and should represent typical job conditions. The purpose of this phase is to condition the new manufactured cable to a stable state that the behavior of the cable specimen will be close to the cable being used in the field. The longitudinal CTE a is determined by the measured elongation of the cable while temperature changes.

Cyclic loading phase: In this phase, the cable specimen is cyclically loaded to the peak load under a fast-loading rate. A 30-second cycle period is utilized. Selection of the loading speed should avoid significant creep or relaxation in the specimen. This phase is conducted at constant temperature. Data obtained from this phase are used to calibrate the instantaneous properties such as J₀ of the cable.

Creep phase: In this phase, the required tension and temperature are applied to the cable specimen for an extended time of 20 hours or until elongation of the cable drops to negligibly small and below 0.001% per hour. This phase is conducted at constant temperature. Data from this phase are used to calibrate the coefficients Jᵢ of the Prony series in equation (4).

### Results and Discussion

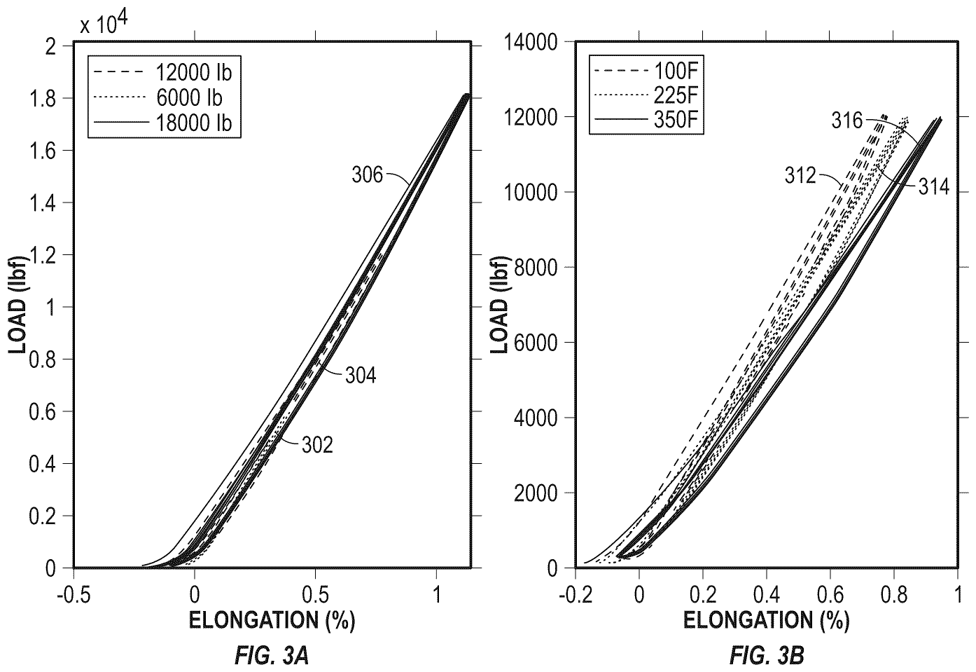

FIG. 3A shows load elongation curves 302, 304, and 306 under cyclic tension for different loads. Load elongation curve 302 shows the load elongation of the cable specimen under 6,000 pounds (lbs) of force. Load elongation curve 304 shows the load elongation of the cable specimen under 12,000 lbs of force. Load elongation curve 306 shows the load elongation of the cable specimen under 18,000 lbs of force. It is seen that the cable shows a small hysteresis in the loading/unloading curve where small difference in load exists between loading and loading. This is an indication of the viscoelastic response of the cable. Another observation is a quite consistent stiffness response for different peak loads.

FIG. 3B shows load elongation curves 312, 314, and 316 under cyclic tension for different temperatures under a 12,000 lb load. Load elongation curve 312 shows the load elongation of the cable specimen at 100 degrees Fahrenheit. Load elongation curve 314 shows the load elongation of the cable specimen at 225 degrees Fahrenheit. Load elongation curve 312 shows the load elongation of the cable specimen at 350 degrees Fahrenheit. The stiffness shows a significant dependency on temperature, decreasing with increase of temperature. Temperature-dependent J₀ is determined from these data.

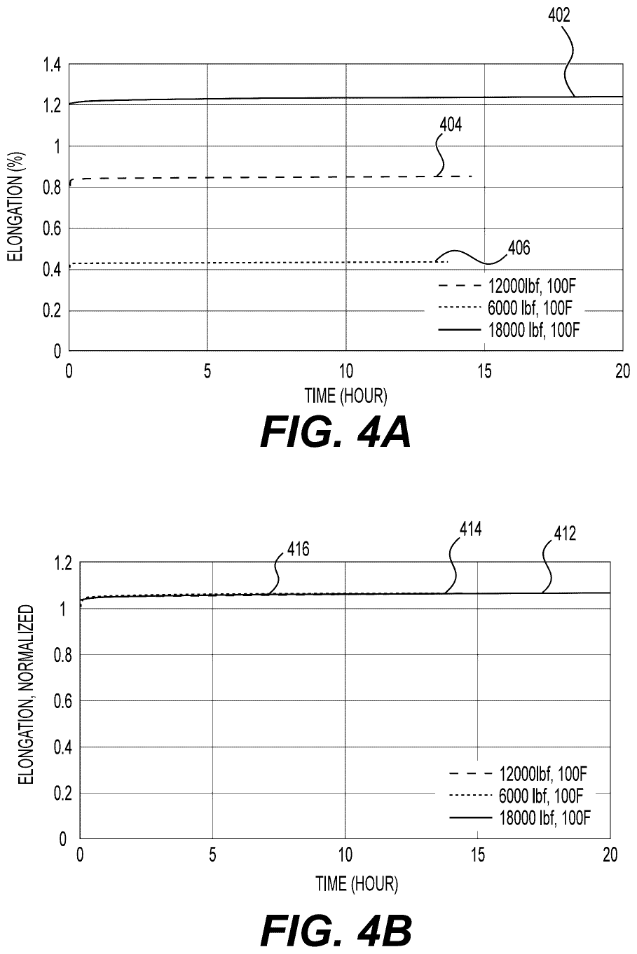

FIGS. 4A and 4B show the creep results of the cable under different tension loads. FIG. 4A shows the absolute creep with the creep curve 402 showing the absolute creep of the wire under 18,000 lbf, the creep curve 404 showing the absolute creep of the wire under 12,000 lbf, and the creep curve 406 showing the absolute creep of the wire under 6,000 lbf. As can be seen in FIG. 4A, the absolute creep is small, about 0.2% over 20 hours; however, for long cable length (e.g., >10,000 ft) and potentially longer dwell time, the extension of the cable due to creep is significant (>20 ft).

FIG. 4B shows the normalized creep results from FIG. 4A. Elongation curve 412 is the normalized representation of creep curve 402, elongation curve 414 is the normalized representation of creep curve 404, and elongation curve 416 is the normalized representation of creep curve 406. As seen in FIG. 4B, the creep response is linear, represented by the overlapped elongation curves 412, 414, and 416 at different loads after normalized with their initial elongations. This justifies using of a linear viscoelastic model to describe the creep behavior of the wireline cable.

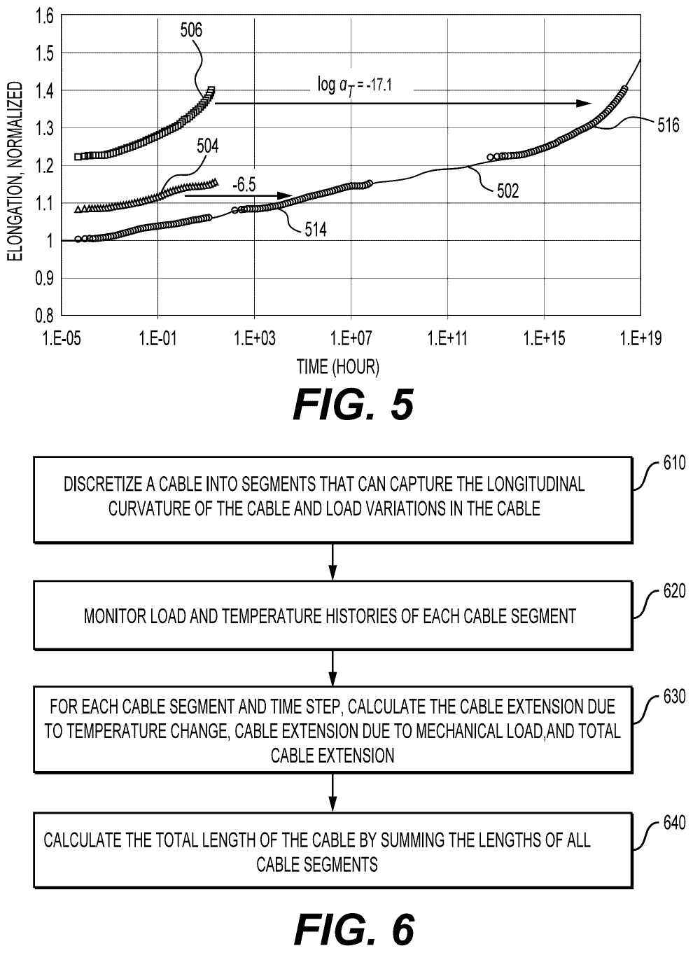

FIG. 5 shows development of the creep master curve 502 using the test creep data under different temperatures. The room temperature is selected as the reference temperature. The creep curves at elevated temperatures of 225 degrees Fahrenheit (creep curve 504) and 350 degrees Fahrenheit (creep curve 506) are shifted horizontally to obtain a single curve that spans a wide range of time from zero to 1e19 hours. Curve segment 514 represents the shift of creep curve 504, and curve segment 514 represents the shift of creep curve 516. The master curve 502 is used to calibrate the coefficients Jᵢ, (i=1 . . . N) in a compliance Prony series. Note that the master curve 502 describes the creep behavior under the reference temperature; however, with knowing how the time-temperature shifting is made, creep at other temperatures can be also determined by the master curve. For this cable, a polynomial equation is used to correlate time and temperature:

$$log {a}_{T} = {C}_{1} ( θ - {θ}_{ref} ) + {{C}_{2} ( θ - {θ}_{ref} )}^{2} \qquad ( 6 )$$

where a_{T} is the time shift, and C₁ and C₂ are two coefficients of the quadratic equation.

The calibrated cable constitutive model considers elongation of the cable due to thermal, elastic, and creep. The model is verified in ABAQUS with a finite element model constructed with beam elements by comparing the model predicted creep of the cable with test measurement. The result indicates a good capability of the constitutive model to capture the test measured overall elongation of the cable.

The calibrated constitutive model allows for efficient calculation of the stretch of wireline cable under tension and temperature and can be used for real-time depth control in wireline jobs. FIG. 6 is an illustration of an example method for predicting length changes of a wireline cable in field operations. At stage 610, a computing device can process a representation of a cable by discretizing the cable into a plurality of segments or finite elements along its longitudinal axis. The computing device can be one or more processor-based devices, such as a server, personal computer, tablet, or cell phone. Each segment can be defined by a set of spatial coordinates and associated physical parameters, thereby enabling the representation of local variations in cable geometry and loading conditions. The discretization facilitates modeling of the cable's longitudinal extension, which may vary as a function of deployment configuration, external constraints, or environmental influences. Additionally, the segmented representation permits the assignment and tracking of load variations, such as those arising from changes in axial tension and thermal expansion or contraction due to temperature gradients along the cable length. This data structure enables numerical simulations, optimization routines, or control algorithms to account for spatially distributed mechanical and thermal effects within the cable system.

At stage 620, the computing device can monitor and record load (θ(t)) and temperature histories (T(t)) of each cable segment. This monitoring can include acquiring time-resolved data corresponding to axial tension and torsional stress, as well as thermal conditions such as local temperature or temperature gradients. Such data may be obtained from one or more sensors distributed along the cable, including but not limited to fiber optic sensors (e.g., distributed temperature sensing (DTS) or distributed strain sensing (DSS) systems), strain gauges, or thermocouples. Alternatively or additionally, the load and temperature values can be derived from physics-based models or simulations that use environmental inputs and boundary conditions to estimate segment-specific states. The resulting load and temperature histories can be stored in memory and updated over time to capture transient and steady-state behaviors, enabling the computing device to perform real-time or post-process analysis of cable performance, degradation, and risk of failure due to cumulative mechanical and thermal stresses.

At stage 630, for each cable segment and time step, the computing device can compute the cable extension (ε_{θ}) due to temperature change, cable extension (ε_{T}(t)) due to mechanical load, and the total cable extension ε(t)=ε_{θ}+ε_{T}(t). Specifically, the cable extension due to temperature change can be determined using the thermal expansion relationship, which may involve the product of the segment's original length, the temperature change relative to a reference state, and the material-specific coefficient of thermal expansion. Concurrently, the cable extension due to mechanical load can be computed based on axial tension or stress applied to the segment, using constitutive relationships such as Hooke's Law, wherein the extension is proportional to the applied force and inversely proportional to the cable's axial stiffness or Young's modulus. The computing device can then sum the thermally induced and load-induced extensions to determine the total extension of the segment at that time step. This total extension may be used to dynamically update the cable's geometric configuration, inform boundary condition adjustments in a simulation, or serve as input for higher-level control, diagnostic, or predictive maintenance algorithms.

At stage 640, the computing device can calculate the total length of the cable by computing the sum of the individual lengths of all discretized cable segments. Each segment's length may be dynamically updated at each time step to account for local changes due to thermal expansion, mechanical elongation under load, or both, as previously calculated. The updated total cable length reflects the aggregate deformation behavior of the cable over time and may vary in response to environmental conditions, operational loads, or deployment configurations. This total length calculation enables accurate tracking of the cable's deployed or effective length in real-time and may be used to adjust models of the cable's spatial profile, enforce geometric constraints, or support downstream calculations, such as determining the position of tools or sensors attached to the cable. The summation process may be performed numerically using a loop or vectorized operation over the array of segment lengths maintained in system memory, allowing the computing device to maintain an up-to-date global representation of the cable's longitudinal state.

In one embodiment of the present invention, a method for monitoring cable creep using a constitutive model is disclosed, wherein the constitutive model is one-dimensional and represented by a Prony series.

In the same embodiment of the present invention, the wireline cable creep may be time-dependent elongation or temperature-dependent elongation.

In another embodiment of the present invention, a method and system characterizing creep of wireline cables is disclosed, whereby the method comprises the steps of providing a wireline cable with a gauge section, fixing a first end of the wireline cable, connecting a second end of the wireline cable to a load cell, wherein the load cell applies and controls tension on the wireline cable, attaching a extensometer to the first end and the second end of the wireline cable, wherein the extensometer is used to measure the length change of the gauge section, and recording one or more data of the wireline cables to characterize the creep of the wireline cables, wherein the one or more data recorded elongation of the wireline cables, tension of the wireline cable, and/or temperature.

In the same embodiment of the present invention, the elongation of the wireline cables is time-dependent elongation or temperature-dependent elongation.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and BLU-RAY disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for monitoring cable creep using a constitutive model, comprising:
discretizing a cable into a plurality of segments along a longitudinal axis of the cable;
applying a tensile load to the cable;
raising an ambient temperature surrounding the wire to a predetermined temperature;
recording load and temperature measurements of each of the plurality of segments;
for each cable segment and time step, calculating, using a constitutive model, an extended length by aggregating individual contributions from the ambient temperature and the tensile load; and
calculating a total extended length of the cable by computing a sum of the extended lengths of all discretized cable segments.

2. The method of claim 1, wherein the extended length by aggregated in one dimension.

3. The method of claim 1, wherein the constitutive model is represented by a Prony series.

4. The method of claim 1, wherein the constitutive model is modeled with linear viscoelasticity using the Voigt-Wiechert model.

5. The method of claim 1, wherein the wireline cable creep is time-dependent elongation or temperature dependent elongation.

6. A method for characterizing creep of wireline cables, the method comprising:
providing a wireline cable with a gauge section;
fixing a first end of the wireline cable;
connecting a second end of the wireline cable to a load cell, wherein the load cell applies and controls tension on the wireline cable;
attaching an extensometer to the first end and the second end of the wireline cable, wherein the extensometer is used to measure the length change of the gauge section; and
recording one or more data of the wireline cables to characterize the creep of the wireline cables.

7. The method of claim 6, wherein the one or more data recorded elongation of the wireline cables, tension of the wireline cable, and/or temperature.

8. The method of claim 7, wherein the elongation of the wireline cables is time-dependent elongation or temperature-dependent elongation.

9. A system for monitoring cable creep, the system comprising:
a processor;
memory accessible to the processor; and
processor-executable instructions stored in the memory and executable by the processor to instruct the system to monitor cable creep using a constitutive model by performing stages comprising:
discretizing a cable into a plurality of segments along a longitudinal axis of the cable;
applying a tensile load to the cable;
raising an ambient temperature surrounding the wire to a predetermined temperature;
recording load and temperature measurements of each of the plurality of segments;
for each cable segment and time step, calculating, using a constitutive model, an extended length by aggregating individual contributions from the ambient temperature and the tensile load; and
calculating a total extended length of the cable by computing a sum of the extended lengths of all discretized cable segments.

10. The system of claim 9, wherein the constitutive model is one-dimensional.

11. The system of claim 9, wherein the constitutive model is represented by a Prony series.

12. The system of claim 9, wherein the wireline cable creep is time-dependent elongation or temperature-dependent elongation.
